(19) United States
(12) Patent Application Publication
(10) Pub. No.: US 2018/0189855 A1
(43) Pub. Date: Jul. 5, 2018

(54) METHOD OF RESERVING AND PRESELLING AIRCRAFT PARTS

(71) Applicant: Gary Philip Hochman, Delray Beach, FL (US)

(72) Inventor: Gary Philip Hochman, Delray Beach, FL (US)

(21) Appl. No.: 15/858,178

(22) Filed: Dec. 29, 2017

Related U.S. Application Data
(60) Provisional application No. 62/440,328, filed on Dec. 29, 2016.

(51) Int. Cl. G06Q 30/06; G06Q 10/08; G06Q 30/02

(52) U.S. Cl. CPC G06Q 30/0627; G06Q 10/087; G06Q 30/0283; G06Q 30/0633; G06Q 30/0603

(57) ABSTRACT

A method of reserving and preselling aircraft parts. A list of a plurality of parts of an aircraft is saved on a database of a server. A user may remotely communicate with the server using a computer over a network. The user may search for an aircraft part saved on the database. If the user finds the part, the user may select the part and a reservation is generated. The remote server receives the reservation to harvest the part from the airplane. The part is then removed from the aircraft based on the reservation. The part is then shipped to the user.

### CROSS-REFERENCE TO RELATED APPLICATION

This application claims the benefit of priority of U.S. provisional application No. 62/440,328, filed Dec. 29, 2016, the contents of which are herein incorporated by reference.

### BACKGROUND OF THE INVENTION

The present invention relates to a system and method of selling aircraft parts and, more particularly, to a system and method of reserving aircraft parts prior to the aircraft being taken apart.

Traditionally when aircrafts are retired or sold, the parts that make up the aircraft are worth more when they are sold separately. Most tear down companies remove the most valuable parts first and store them for resale. The remaining parts of the aircraft are further disassembled, and the parts are cataloged and added to stock in As Removed condition inventory. The parts are not offered for sale until they are removed, inspected, tagged, warehoused and entered into a company's computer inventory system to offer for sale. The above-mentioned process may take several days to several months, which results in lost sales and turnaround opportunities.

As can be seen, there is a need for a more efficient system and method for selling aircraft parts from a retired aircraft.

### SUMMARY OF THE INVENTION

In one aspect of the present invention, a method of reserving aircraft parts comprises: accessing, using a computer, a list of a plurality of parts of an aircraft stored on a database of a remote server; receiving, using the computer, a selection by a user of at least one of the plurality of parts from the list; and causing, using the computer, a reservation to be generated based on the selection of the at least one of the plurality of parts; wherein the remote server receives the reservation, the at least one of the plurality of parts is removed from the aircraft based on the reservation to be delivered to the user.

In another aspect of the present invention, a method of providing aircraft parts comprises: acquiring an aircraft; publishing, using a web server, a list of a plurality of parts of the aircraft stored on a searchable database; receiving, by the web server, a reservation from a remote computer, the reservation comprising a selection by a user of at least one of the plurality of parts; removing the at least one of the plurality of parts from the aircraft based on the reservation; and shipping the at least one of the plurality of parts to the user.

These and other features, aspects and advantages of the present invention will become better understood with reference to the following drawings, description and claims.

### BRIEF DESCRIPTION OF THE DRAWINGS

FIG. 1 is a flowchart of an embodiment of the present invention;

FIG. 2 is a schematic view of an embodiment of the present invention;

FIG. 3 is a schematic view of an embodiment of the present invention; and

FIG. 4 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method for ordering and reserving parts from a tear down aircraft. A materials parts list for the brand and model of the aircraft and a materials parts list for the brand and model of engine are retrieved from the manufacturers or other sources. The parts are then posted and available for sale online before the aircraft is dissembled. This enables the immediate sale of the parts of the plane in As Removed condition, which significantly speeds up the process of selling the parts and buying parts at a lower cost versus the traditional method used in the industry with double freight, warehousing and administrative and financial costs.

The present invention includes a pre-sales database for buyers of aircraft parts, which gives them access to parts in the marketplace in advance of availability to reserve the parts for purchase. The present invention provides a new methodology to reserve a part, get a repair cost, make an offer, negotiate the part price and check the aftermarket price for similar parts to insure the buyer is saving money. The present invention also enables owner operators to have parts purchased, overhauled and shipped to a maintenance facility for installation before the aircraft arrives for repair rather than take the existing part off the aircraft after it arrives and wait for it to be repaired. The present invention reduces the time for D and C check repairs, thereby saving the owner operator significant costs. The present invention may also provide for valuable tracking and pricing data on the reserved and sold parts which can generate market pricing, parts inquiry, sales conversion data, and save data required by the industry and the FAA.

Broadly, the present invention includes a method of reserving aircraft parts. The present invention includes acquiring an original equipment manufacturer (OEM), on condition or condition monitoring (OCCM) or other type of list of a plurality of parts of an aircraft that is ready to be dismantled. The list of parts are saved on a database of a server. A user may remotely communicate with the server using a computer over a network. The user may search for an airplane part saved on the database. If the user finds the part, the user may select the part and a reservation is generated. The remote server receives the reservation to harvest the part from the airplane. The part is then removed from the aircraft based on the reservation. The part is then shipped to the user.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

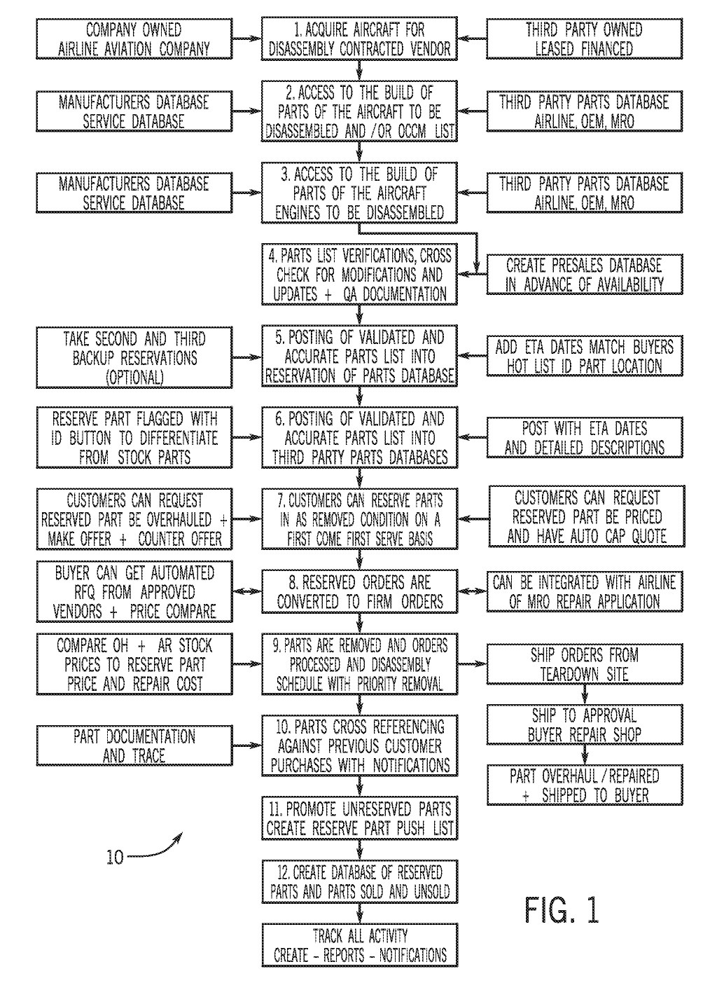

Referring to FIG. 1, the airplane to be dismantled is first acquired or owned 1 by a company. The company may include a disassembly company that disassembles the airplane based on received reservations. Alternatively, the company may hire a disassembly company to disassemble the airplane upon the company's request. The company may then access a list of the parts of the aircraft body to be disassembled 2 as well as a list of the parts of the aircraft engine to be disassembled 3. The aircraft body parts may include, but are not limited to, retables, repairables, avionics, interior, exterior parts and control surfaces. The list of parts may be found based on the brand and type of aircraft and engine. The parts list may be retrieved from the manufacturers database and/or a third-party database that had either replaced a part of the aircraft or repaired a part of the aircraft. The above-mentioned databases provide the part numbers, the age of the parts and the history of the parts. The parts list is then verified by cross checking for modifications and updates 4, to ensure the parts have been properly serviced and maintained under FAA regulations. Once the parts have been verified, the parts list is uploaded to the database to be posted (published) over the network, such as the Internet.

The list of the parts are posted over the network from a searchable database of the server. When the list of parts are posted, a user (customer) using a remote computer may access the list of parts. For example, the user may visit the website of the server and search for a part or a group of parts. The part may be presented to the user if available and the user may select the part to make a reservation. The list of parts may also be posted on a third-party web server 6. If the list of parts are posted on a third party web server, the parts may be clearly listed as a reserve part to differentiate from stock parts. Each of the parts may further include an estimated time of arrival. The estimated time of arrival provides an estimate of when the reserved part will be harvested from the aircraft and then shipped to the user.

In certain embodiments, the user may add a hot list using the remote computer. The hot list includes a plurality of parts that are desired by the user. The user is then notified by the server when at least one of the parts of the aircraft matches at least one of the desired parts of the user. The user is then given the option to reserve the part(s).

The user can reserve the searched part on a first come first serve basis 7. In certain embodiments, each of the parts may be reserved by more than one user, thereby creating backup reservations. Therefore, if a first user reserves a part, but then receives a quote that is too high for their budget, a second user that reserved the part is notified that the part is now available. Once the user reserves a part, the user is given an option to request a cost for the part. If the user requests a cost evaluation, the request is forwarded to the remote web server. Once the cost is determined, the user may view the cost to determine whether they would like to accept the cost or provide a counter offer. The user may send the counter offer to the web server using the remote computer. The company may either accept the counter offer or return a counter offer to the counter offer. If the any offer is accepted by the user, the reservation is generated.

The user may further request that the part be overhauled. In such embodiments, the user may first request a quote from a third-party vendor to overhaul the part. In such embodiments, the request is sent to the web server and the request is then sent to or accessible by the third-party vendor. The third-party vendor generates a quote for overhauling the part and sends the quote to the web server. The quote is then sent to or accessible by the user. In certain embodiments, the user may accept the quote, reject the quote or send a counter offer. The counter offer is sent to or accessible by the third-party vendor. The third-party vendor determines whether to accept the counter offer, reject the counter offer, or provide a counter offer to the counter offer. If the user accepts an offer by the third-party vendor, the part may first be sent to the third-party vendor to be overhauled. Once the part is overhauled, the part is then sent to the user.

After the parts have been reserved and converted to firm orders 8, the parts are removed from the aircraft 9. The parts may either be shipped directly to the user or shipped to the third-party vendor. If the parts are shipped to the third-party vendor, the third-party vendor may overhaul or repair the part. Once the part is overhauled or repaired, the part is sent to the user.

Each of the removed parts may be saved to a database with additional data 12. For example, the buyer of the part and the amount the part sold for may be saved on the database. In such embodiments, parts may be cross referenced against previous customer purchases 10. For example, if a user tends to buy a certain part, the user may be notified by the server when future parts are available for reservation. The unreserved parts may be promoted and added to a reserve part push list 11 to expedite the reservation of the additional parts of the aircraft.

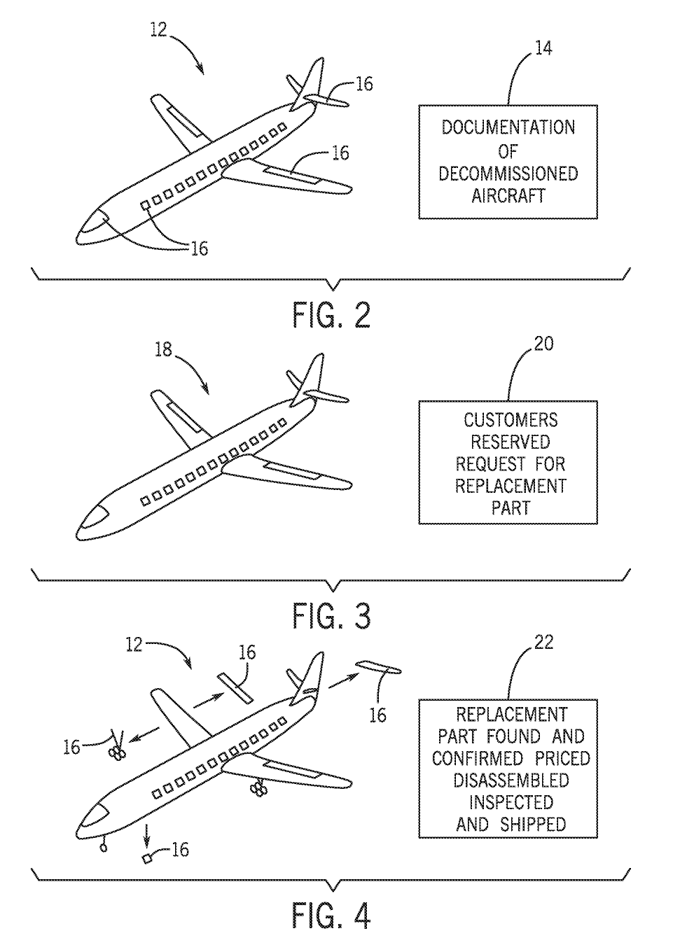

FIGS. 2 through 4 illustrate a schematic view of the method of the present invention. A decommissioned aircraft 12 is first acquired by a first user. The decommissioned aircraft 12 comes with documentation 14 including the list of parts 16 of the aircraft 12, and the repair and replacement information of those parts 16. The parts 16 are uploaded to the database of the web server. A second user that owns an aircraft in need of a replacement part 18 may search the database of the web server for the needed part. The second user may further reserve the replacement part 20 on the web server. The part 16 is found on the decommissioned aircraft 12, a price is confirmed and the part is removed, inspected and shipped 22 to the second user.

It should be understood, of course, that the foregoing relates to exemplary embodiments of the invention and that modifications may be made without departing from the spirit and scope of the invention as set forth in the following claims.

What is claimed is:

1. A method of reserving aircraft parts from a teardown aircraft comprising:
accessing, using a computer, a list of a plurality of parts of an aircraft stored on a database of a remote server;
receiving, using the computer, a selection by a user of at least one of the plurality of parts from the list; and
causing, using the computer, a reservation to be generated based on the selection of the at least one of the plurality of parts; wherein
the remote server receives the reservation, and
the at least one of the plurality of parts is removed from the aircraft based on the reservation to be delivered to the user.

2. The method of claim 1, wherein the list of the plurality of parts comprises a list of a plurality of engine parts and a list of a plurality of aircraft body parts.

3. The method of claim 1, wherein the remote server publishes the list of the plurality of parts of the aircraft on the Internet.

4. The method of claim 3, wherein the remote server retrieves the list of the plurality of parts of the aircraft from a manufacturer database and a third-party parts database.

5. The method of claim 1, wherein the plurality of parts stored on the database are searchable using the computer.

6. The method of claim 1, further comprising the steps of:
receiving, using the computer, a hot list by the user comprising a plurality of desired parts; and
notifying, using the computer, the user when at least of one of the plurality of parts of the aircraft matches one of the plurality of desired parts of the hot list.

7. The method of claim 1, further comprising the step of presenting, by the computer, an estimated time of arrival of the at least one of the plurality of parts.

8. The method of claim 1, further comprising the steps of:
determining, using the computer, a cost of the one of the plurality of parts; and
presenting, using the computer, the cost of the at least one of the plurality of parts to the user.

9. The method of claim 8, wherein determining the cost of the one of the plurality of parts comprises forwarding the reservation to the remote server with a request for a cost calculation, and receiving the cost from the remote server.

10. The method of claim 8, further comprising the step of receiving, using the computer, a counter offer of the cost of the at least one of the plurality of parts.

11. A method of providing aircraft parts comprising:
acquiring an aircraft;
publishing, using a web server, a list of a plurality of parts of the aircraft stored on a searchable database;
receiving, by the web server, a reservation from a remote computer, the reservation comprising a selection by a user of at least one of the plurality of parts;
removing the at least one of the plurality of parts from the aircraft based on the reservation; and
shipping the at least one of the plurality of parts to the user.

12. The method of claim 11, wherein the list of the plurality of parts comprises a list of a plurality of engine parts and a list of a plurality of aircraft body parts.

13. The method of claim 11, further comprising the step of retrieving the list of the plurality of parts of the aircraft from a manufacturer database and a third-party parts database.

14. The method of claim 11, further comprising the steps of:
receiving, by the web server, a hot list from the remote computer, the hot list comprising a plurality of desired parts of the user; and
sending, by the web server, a notification to the remote computer of the user when at least of one of the plurality of parts of the aircraft matches one of the plurality of desired parts of the hot list.

15. The method of claim 11, further comprising the step of sending, by the web server, an estimated time of arrival of the at least one of the plurality of parts to the computer.

16. The method of claim 11, further comprising the steps of:
determining, by the web server, a cost of the one of the plurality of parts; and
sending, by the web server, the cost of the at least one of the plurality of parts to the remote computer.

17. The method of claim 16, further comprising the step of receiving, by the web server, a counter offer of the cost of the at least one of the plurality of parts from the remote computer.

18. The method of claim 11, further comprising the steps of:
receiving, by the web server, a request for a repair quote for the at least one of the plurality of parts;
forwarding, using the web server, the request of the repair quote to a plurality of vendors;
receiving, by the web server, the repair quotes from the plurality of vendors; and
sending, by the web server, the repair quotes of the at least one of the plurality of parts to the remote computer.

19. The method of claim 11, further comprising the step of: receiving, by the web server, a plurality of reservations from remote computers, the reservations comprising a selection by a plurality of users of at least one of the plurality of parts, wherein a priority is assigned to each user based on when the user reserved the part.
